(19) United States
(12) Patent Application Publication
(10) Pub. No.: US 2009/0235191 A1
(43) Pub. Date: Sep. 17, 2009

(54) Method for Accessing a Secondary Virtual Environment from Within a Primary Virtual Environment

(76) Inventors: Zachary A. Garbow, Rochester, MN (US); Michael T. Kalmbach, Elgin, MN (US); Bryan M. Logan, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/045,816

(22) Filed: Mar. 11, 2008

(51) Int. Cl. G06F 3/048

(52) U.S. Cl. 715/764

(57) ABSTRACT

Embodiments of the invention provide a method for distributing data from within a virtual world to multiple hosts. In one embodiment, primary areas within the virtual world may be hosted on servers controlled by the provider of the virtual world. At the same time, some areas within the virtual world may be controlled by a second party and hosted by a secondary server. In the virtual environment, an interface may be provided to access the area controlled by the second party.

### BACKGROUND OF THE INVENTION

Embodiments of the invention relate to presenting users with a virtual world, and more specifically to improving continuity, and security for a virtual world hosting private virtual locations on distinct servers.

### DESCRIPTION OF THE RELATED ART

A virtual world is a simulated environment in which users may inhabit and interact with one another via avatars. An avatar generally provides a graphical representation of an individual within the virtual world environment. Avatars are usually presented to other users using a graphical representation depicting a human-like character. Multiple users “enter” a virtual world by logging on to a central server(s) and interact with one another through the actions of their avatars. The actions of a given avatar are typically controlled by the individual using a mouse and keyboard. Virtual worlds provide an immersive environment with an appearance typically similar to that of the real world, with real world rules such as gravity, topography, locomotion, real-time actions, and communication. Communication may be in the form of text messages sent between avatars, but may also include real-time voice chats.

Virtual worlds may be persistent between times when a given user is logged on. A persistent world provides an immersive environment (e.g., a fantasy setting used as a setting for a role-playing game) that is generally always available, and virtual world events happen continually, regardless of the presence of a given avatar. Thus, unlike more conventional online games or multi-user environments, the events within a virtual world continue to occur for connected users even while are not actively logged on to the virtual world.

### SUMMARY OF THE INVENTION

One embodiment of the invention includes a method of providing access to a secondary virtual environment from within a primary virtual environment hosted on a primary server system. The method may generally include providing a secondary virtual environment hosted on a secondary server system and providing a representation of the secondary virtual environment to be depicted in the primary virtual environment. The representation may include a depiction of an entry point and an access mechanism used to request access to the secondary virtual environment. The method may further include receiving a request to transfer a presence of a client connected to the primary virtual environment to the secondary virtual environment. The presence of the client in the primary virtual environment is represented using an avatar controlled by a user. Upon authenticating the request, the presence of the client is transferred from the primary virtual environment to the secondary virtual environment.

Another embodiment of the invention includes a computer-readable storage medium containing a program which when executed, performs an operation for providing access to a secondary virtual environment from within a primary virtual environment hosted on a primary server system. The operation may generally include providing a secondary virtual environment hosted on a secondary server system and providing a representation of the secondary virtual environment to be depicted in the primary virtual environment. The representation may include a depiction of an entry point and an access mechanism used to request access to the secondary virtual environment. The operation may further include receiving a request to transfer a presence of a client connected to the primary virtual environment to the secondary virtual environment. The presence of the client in the primary virtual environment is represented using an avatar controlled by a user. Upon authenticating the request, the presence of the client is transferred from the primary virtual environment to the secondary virtual environment.

Still another embodiment of the invention includes a system having a processor and a memory, a memory executing a program. The program is generally configured to provide a representation of the secondary virtual environment to be depicted in the primary virtual environment. The representation includes a depiction of an entry point and an access mechanism used to request access to the secondary virtual environment. The program may be further configured to receive a request to transfer a presence of a client connected to the primary virtual environment to the secondary virtual environment, wherein the presence of the client in the primary virtual environment is represented using an avatar controlled by a user. And upon authenticating the request, to grant the request and receive a transfer of the presence of the client from the primary virtual environment to the secondary virtual environment.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1A is a block diagram illustrating a networked system for using multiple servers to divide a virtual world, according to one embodiment of the invention.

FIG. 1B is a block diagram illustrating a client, a guest server, and a primary server within a system for using multiple servers to divide a virtual world, according to one embodiment of the invention.

FIG. 1C is a block diagram illustrating a guest server within a system for using multiple servers to divide a virtual world, according to one embodiment of the invention.

FIG. 2 is an example screen shot of a scene within a virtual world containing elements for accessing a guest environment, according to one embodiment of the invention.

FIG. 3 is a flowchart illustrating a process for an avatar requesting entry into a guest environment, according to one embodiment of the invention.

FIG. 4 is a flowchart illustrating a process for requesting transfer of an object into a guest environment, according to one embodiment of the invention.

### DETAILED DESCRIPTION OF THE PREFERRED EMBODIMENTS

In addition to interacting with one another, users of a virtual environment may affect the virtual environment in a variety of ways, and virtual environments are emerging as an excellent way for individuals to collaborate and conduct business. Accordingly, many businesses, politicians, artists, musicians, entertainers, etc., (to name but a few) have established a presence in well known virtual environments. For example, users may be allowed to acquire a plot of land and to build a virtual house, store, conference room, or other constructs on that plot within the virtual world. Typically however, the data representing such structures, and their contents, is hosted by a single server (or a cluster of servers) controlled by the provider of the virtual world. For personal use, this may not be a concern. However, when the virtual environment is used to conduct certain meetings, a company might not want data representing confidential information to traverse and be stored by the servers controlled by the virtual world provider (e.g., data encoding speech between avatars holding a virtual board meeting or data representing whiteboard drawings depicting a confidential product design). Therefore, there is a need to have parts of the virtual world to be hosted separately from the “main” virtual world.

Embodiments of the invention provide a method for distributing data from within a virtual world to multiple hosts. In one embodiment, primary areas within the virtual world may be hosted on servers controlled by the provider of the virtual world. At the same time, some areas within the virtual world may be controlled by a second party and hosted by a secondary server. In the virtual environment, an interface may be provided to access the area controlled by the second party. For example, the exterior elements of a virtual house may be hosted on the main provider's servers, and a door to the house may provide an interface between the “main” virtual environment and the private environment hosted by the third party. In such a case, an avatar standing at the window of a house may look outside and see a view of the main world with information pulled from the main server hosting the exterior of the house and the street. At the same time, an avatar walking down the street looking at the house would be presented with a display of an exterior of the house, but would not see the interior.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

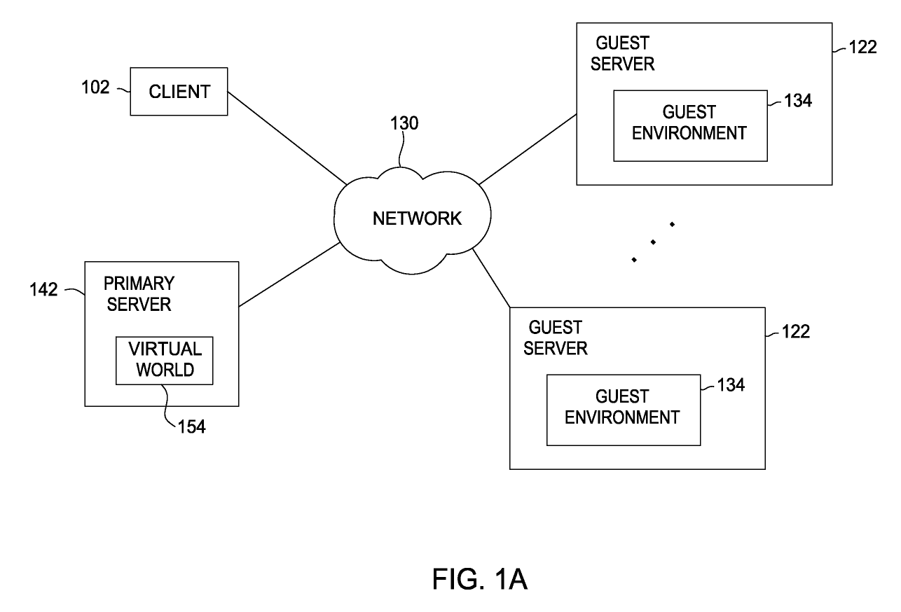

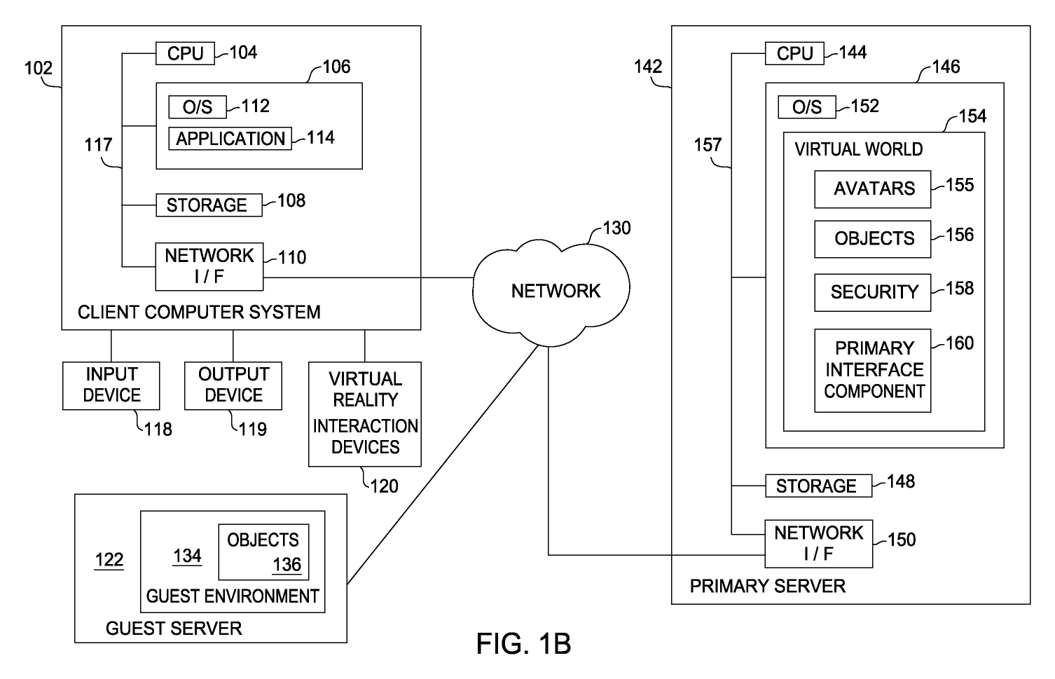

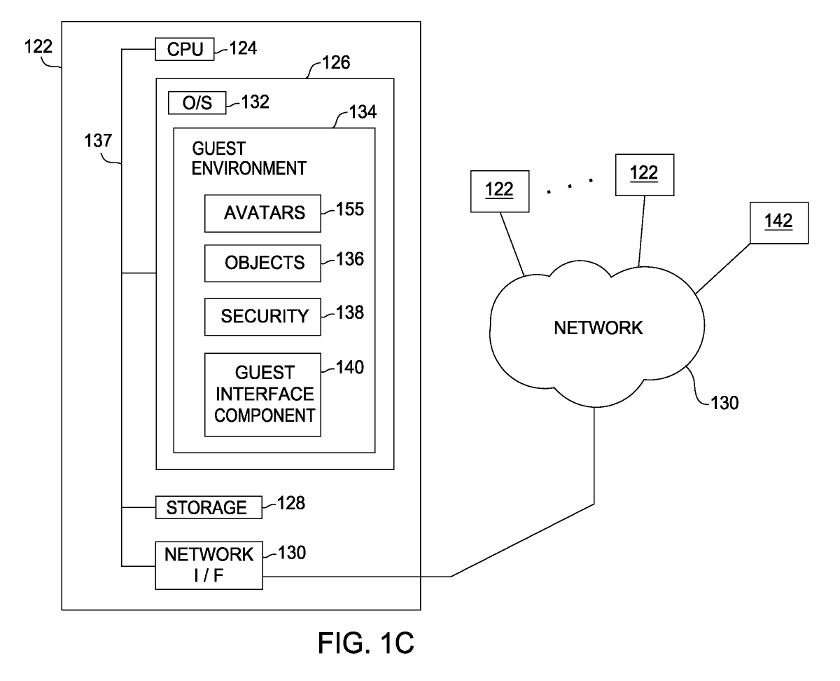

FIG. 1A is a block diagram illustrating a networked system 100 for using multiple servers to divide a virtual world, according to one embodiment of the invention. As shown, the networked system 100 includes multiple client computers 102, guest servers 122, and a primary virtual world server 142. Also, the client computers 102, guest servers 122, and the primary server 142 are connected via a network 130. In general, the network 130 may be any data communications network (e.g., a TCP/IP network such as the Internet) configured to allow client computers 102, guest servers 122, and the primary server 142 to communicate with one another.

In one embodiment, a user on the client 102 may interface with the primary server 142 to connect to, explore and interact with the virtual world 154 using an avatar representation of that user. Further, the virtual world 154 may include links to one or more guest environments 134 on the guest server 122. In one embodiment, a guest server 122 may host a guest environment 134 located within the virtual world 154. The content of the guest environment 134 may be maintained separately from the primary server 142 for purposes of privacy, security, or implementation freedom. For example, a user on client 102 may interact with the virtual world 154. Further, once in the virtual world 154, the user may access a guest environment 134 hosted on a guest server 122 distinct from the primary server 142.

The guest environment 134 may implement its own local rules, some of which may conflict with rules implemented on the virtual world 154. While some rules could be thought of as “local ordinances” regarding how avatars interact with the environment or with one another, other rules in a guest environment could be used to alter features of the environment provided by the primary virtual world 154. For example, the primary virtual world 154 may be constructed with rules corresponding to physics, gravity and motion of the real world (e.g., an object when dropped, falls to the ground), where such rules may be altered (or revoked) in the guest environment. 134. This provides developers of the guest environment 134 with broad flexibility in designing private spaces connected to the primary virtual world 154. For example, the guest environment 134 may be a virtual playground where avatars 155 have special powers to fly and pass through solid objects. In other cases, however, the guest environment 134 may provide a more private space where individuals may collaborate with one another (e.g., a business holding a virtual board meeting or a politician conducting a campaign strategy meeting with a group of advisors).

Similarly, the primary virtual world 154 or the guest environment 134 may impose rules on what objects may traverse between the two. For example, assume a guest environment 134 allowing a group of engineers to collaborate on a product design prototype; such an environment may be constructed so as to prevent an avatar from taking a copy of the virtual product prototype from the guest environment 134 to the primary virtual world 134.

According to one embodiment, if the guest server 122 suffers an outage, continuity and integrity of the virtual world may be maintained by preventing the user from interacting with the guest environment 134 on that server 122. More specifically, transfers of avatars to the guest environment may be prevented. If the interior appearance of the guest environment 134 is hidden from the view of users in the virtual world 154, the user may be prevented from opening the door. Where the interior appearance of the guest environment is visible to users in the virtual world, the appearance may be temporarily frozen. For example, if the virtual world 154 has an “open view” of the guest environment 134 from the virtual world 154, then the virtual world 154 may display a cached view of the guest environment 134 until the guest server 122 is responsive.

FIG. 1B is a block diagram illustrating a client computer 102, a guest server 122, and a primary server 142 within a system for using multiple servers to divide a virtual world, according to one embodiment of the invention. As shown, the client 102 includes a Central Processing Unit (CPU) 104 connected via a bus 117 to memory 106, storage 108, a network interface device 110, an input device 118, and an output device 119.

The CPU 104 could be any CPU used to perform an embodiment of the invention. The client 102 is generally under the control of an operating system 112, which is shown in the memory 106. Examples of operating systems 112 include a UNIX® distribution such as IBM AIX®, versions of the Microsoft Windows® operating system, and distributions of the Linux® operating system. (Note: Linux is at trademark of Linus Torvalds in the United States and other countries.) More generally, any operating 112 system supporting the functions disclosed herein may be used.

Illustratively, memory 106 also includes a client application 114. In one embodiment, client application 114 provides a software program that allows a user to connect to a virtual world 154, and a guest environment 134, and once connected, to explore and interact with the virtual world 154 and guest environment 134 using an avatar representation of that user. Further, client application 114 may be configured to generate and output visual and/or audio representations of objects 136, 156 within the guest environment 134 and virtual world 154, based on visual and audio descriptions within the guest environment 134 and virtual world 154.

Storage 108 represents any combination of fixed and/or removable storage devices, such as fixed disc drives, floppy disc drives, tape drives, removable memory cards, flash memory storage, or optical storage. The network interface device 110 may allow network communications between the client 102, the guest servers 122, and the primary server 142 via the network 130. The input device 118 can be any device to give input to the client 102. For example, a keyboard, keypad, light pen, touch-screen, track-ball, microphone, speech recognition unit, and the like could be used.

The output device 119 can be any device configured to present the guest environment 134 and virtual world 154 and accompanying objects 136, 156 to the user, e.g., a CRT or LCD monitor along with a set of audio speakers. Although shown separately from the input device 118, the output device 119 and input device 118 could be combined. For example, a display screen with an integrated touch-screen, integrated keyboard, or a speech recognition unit combined with a text-to-speech converter could be used.

Further, in one embodiment, the user may interact with client application 114, guest environment 134, and virtual world 154 using a variety of virtual reality interaction devices 120. For example, the user may don a set of virtual reality goggles that have a screen display for each lens. Further, the goggles could be equipped with motion sensors that cause the view of the guest environment 134, or virtual world 154 presented to the user to move based on the head movements of the individual. As another example, the user could don a pair of gloves configured to translate motion and movement of the user's hands into avatar movements within the guest environment 134 or virtual world 154. Of course, embodiments of the invention are not limited to these examples and one of ordinary skill in the art will readily recognize that the invention may be adapted for use with a variety of devices configured to present the guest environment 134 and virtual world 154 to the user and to translate movement/motion or other actions of the user into actions performed by the avatar representing that user within the guest environment 134 and virtual world 154.

Primary server 142 may be similarly constructed as the client 102. Accordingly, as shown, primary server 142 includes a CPU 144, a memory 146, a storage device 148, and a network interface device 150, coupled to one another by a bus 157. Programming and data structures contained within the memory 146 and storage 148 may be accessed and executed by the CPU 144 as needed to allow users to connect to, and interact with both one another and objects 156 of the virtual world 154.

Illustratively, the memory 146 includes the virtual world 154, and an operating system 152. And the virtual world 154 includes avatars 155, objects 156, a security component 158, and a primary interface component 160. Collectively, objects 156 represent the content presented to users interacting with the virtual world 154, such as visual and audio elements presented to users exploring the virtual world 154 with their avatar 155.

One example of an object 156 includes the exterior of the guest environment 134 as it appears to users in the virtual world 154. In such a case, the virtual world 154 generates data supplied to client application 114 in order to present the exterior of the guest environment 134 to users exploring the virtual world 154. Further, objects 156 may include a visual representation of a security interfaces by which avatars 155 may request access to a guest environment 134 hosted by guest server 122, for example, such an object may be have the appearance of a keypad accessed by an avatar 155 using something known to the avatar (e.g., a pin code) or lock accessed by an avatar 155 using something possessed by the avatar (e.g., another object 156 representing a key. In another embodiment, the object of the virtual world itself may be configured to verify an avatars authorization to enter the guest environment 134. For example, a doorknob may retrieve the user ID of the person attempting to turn it, and then check the retrieved ID against a list of “approved” people. The ID may be represented as a name or number. In such a case, the avatar may not need to enter a PIN or use an object in their possession. Also, the authentication may be a combination of two or more of these techniques.

The security component 158 may include authentication software for validating access requests (e.g., an avatar 155 entering an access code) for avatars 155 and objects 136 moving from the virtual world 154 to the guest environment 134 (or vice versa). The primary interface component 160 may include software to allow objects 136, 156, and avatars 155 to traverse between the virtual world 154 and guest environments 134. In one embodiment, to maintain object integrity, the virtual world 154 may track objects 156 (regardless of whether a particular object 156 is in a guest environment 134). When an object 156 is in a guest environment 134, the primary interface component 160 may record the object's location as being within the specific guest environment 134. Once an object 156 returns to the virtual world 154 from the guest environment 134, the primary interface component 160 may verify the object's integrity and continue to track the object 156. If an object 156 is not recognized by the primary interface component 160, the virtual world 154 may present an image of the object 156 disappearing from the avatar's possession. Alternatively, the user may be notified that the object 156 cannot be taken out of the guest environment 134. Accordingly, a ‘rogue’ guest server cannot copy and/or modify legitimate objects 156 and force them into the virtual world 154. Similarly, objects 136 intended to stay in the guest environment 134 may be prevented from being exposed to the virtual world 154.

FIG. 1C is a block diagram illustrating a guest server 122 within a system for using multiple servers to divide a virtual world, according to one embodiment of the invention. The guest server 122 may be similarly constructed as the primary server 142. Accordingly, as shown, the guest server generally includes a CPU 124, a memory 126, a storage device 128, and a network interface device 130, coupled to one another by a bus 137. Programming and data structures contained within the memory 126 and storage 128 may be accessed and executed by the CPU 124 as needed to allow users to connect to, and interact with both one another and with objects 136 of the guest environment 134.

As shown, the memory 126 includes an operating system 132 and the guest environment 134. The guest environment 134 includes objects 136, avatars 155, a security component 138, and a guest interface component 140. Like the objects 156 within the virtual world 154, objects 136 represent the content presented to users interacting with the guest environment 134, such as visual and audio elements presented to users exploring guest environment 134 with their avatar 155.

In some embodiments, the exterior of the guest environment 134 may be one example of an object 136. In such a case, the guest environment 134 generates the appearance of the virtual environment's exterior 136 as presented to users exploring the virtual world 154.

The security component 138 may include authentication software used to validate requests for access to the guest environment 134 made by avatars 155 and objects 156 passing from the virtual world 154. For example, a user may enter a PIN on a keypad in the virtual world 154 to access the guest environment 134 from the virtual world 154. In such a case, the security component 138 may validate the user-entered PIN to determine whether the requesting user/avatar is authorized to enter the guest environment 134. In a scenario where the avatar 155 requesting access to the guest environment 134 is in possession of an object 156, the security component 138 may validate an identifier associated with the object 156 to determine whether the object 156 is authorized to pass into the guest environment 134. For example, objects in the virtual world 154 may be governed by rules that prohibit the unauthorized duplication or removal of certain objects 156.

In a case where the object 156 is not authorized to pass into the guest environment 134, the guest environment 134 may present an image to the user where the object 156 disappears from the user's avatar's possession upon entry into the guest environment 134. In another embodiment, an avatar 155 may be denied entry into a guest environment 134 if all objects 156 in the avatar's possession are not authorized entry into the virtual environment. Rules regarding what objects 156 may be defined by the virtual world 154, by the guest environment 134, or both.

The guest interface component 140 may include software to provide access to the virtual environment for objects 136, 156, and avatars 155 that pass between the virtual world 154 and guest environments 134. For example, the guest interface component 140 may receive the access request described above and invoke the security component 138 for authentication. After authentication, the guest interface component 140 may return a Boolean value specifying whether the access request is granted. For access requests that are granted, the guest interface component 140 may handle the calls from the virtual world 154 that effectuate the transfer of avatars 155, and/or objects 156 into the guest environment 134.

In one embodiment, avatars 155 may bring objects 136 into the guest environment 134 or return with objects 156 previously removed from the virtual world 154. In such a case, the guest interface component 140 may employ a protocol whereby the object 136 is signed and validated by the security component 158 on the primary server 142, which allows such an object 136 to be brought into the virtual world 154.

FIGS. 1A-1C illustrate merely one hardware/software configuration for the networked client computer 102, guest servers 122, and primary server 142. Embodiments of the present invention may be adapted for use with a broad variety of computer hardware and software, regardless of whether the computer systems are complicated, multi-user computing apparatus, single-user workstations or network appliances that do not have non-volatile storage.

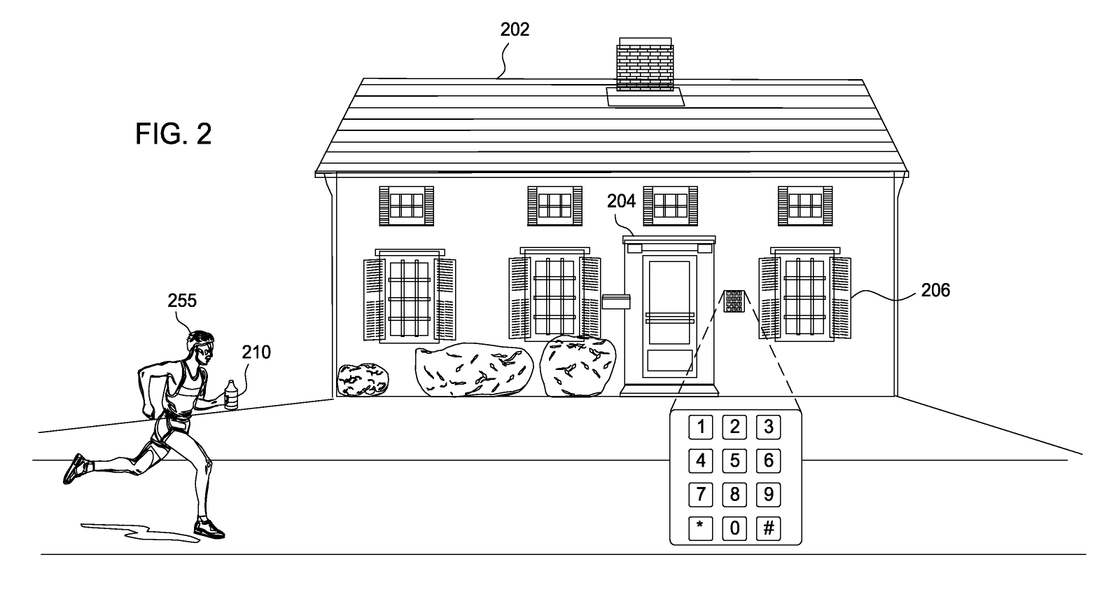

FIG. 2 is an example screen shot 200 of a scene within a virtual world 154 containing elements for accessing a guest environment 134, according to one embodiment of the invention. As shown, screen shot 200 presents a display of a guest environment, presented as a building 202 and an avatar 255 carrying a water bottle 210. Illustratively, the building 202 includes a doorway 204, and a security keypad 206. As shown, the avatar 255 is carrying a water bottle 210.

In this example, assume that the interior of building 202 is hosted as by a guest environment 134 running on a guest server 122, as described above. In such a case, the avatar 255 may request entry into the guest environment 134 by entering an access code using the keypad 206. Of course, any type of security interface could be presented to avatars wishing to enter guest environments 134. In one embodiment, security interfaces could require knowledge, such as a pass-code or PIN. Alternate embodiments of security interfaces could require virtual world objects 156, such as a virtual key, or swipe card that could be applied to a virtual door-lock to request authentication for entry into the guest environment 134.

In response to the access request, e.g. PIN entry, the primary interface component 160 may send an authentication request to the guest interface component 140. In turn, the security component 138 may authenticate the PIN, key, swipe card, etc., and return a Boolean value specifying whether or not access is granted to the requesting avatar 255. Provided access is granted, the doorway 204 may open and allow the avatar 255 to pass from the virtual world 154 (presented as the exterior of building 202) to the guest environment 134 (presented as the interior of building 202). In one embodiment, the guest interface component 140 may be configured to pass data representing the presence and appearance of avatar 155 from the virtual world 154 to the guest interface component 140. In turn, the guest interface component 140 may be configured to introduce the avatar 155 into the guest environment 134. Objects possessed by the avatar 155 (e.g., water bottle 210) may be similarly processed, as well as being evaluated by the primary interface component 160 and the guest component 140 according to rules governing what objects may move between the virtual world 154 and guest environment 134.

Those skilled in the art recognize that there are numerous potential embodiments of security interfaces that employ user knowledge, security interfaces, virtual world objects 156, or some combination of the two. The previous discussion provides mere examples of security interface embodiments where components on the guest server 122 authenticate credentials obtained from the requesting user with assistance from components on the primary server 142.

In a scenario where the guest server 122 is unavailable, e.g. due to a hardware or software failure, access requests sent to the guest interface component 140 may time out. Accordingly, the keypad 206 may translate the time-out response as an authentication failure and deny entry to the avatar 255. Alternately, when the guest server 122 is unavailable, other embodiments may disable security interfaces such as the keypad 206 to prevent entry of a PIN, or overlay the image of the keypad 206 with a message such as, “Guest environment unavailable.”

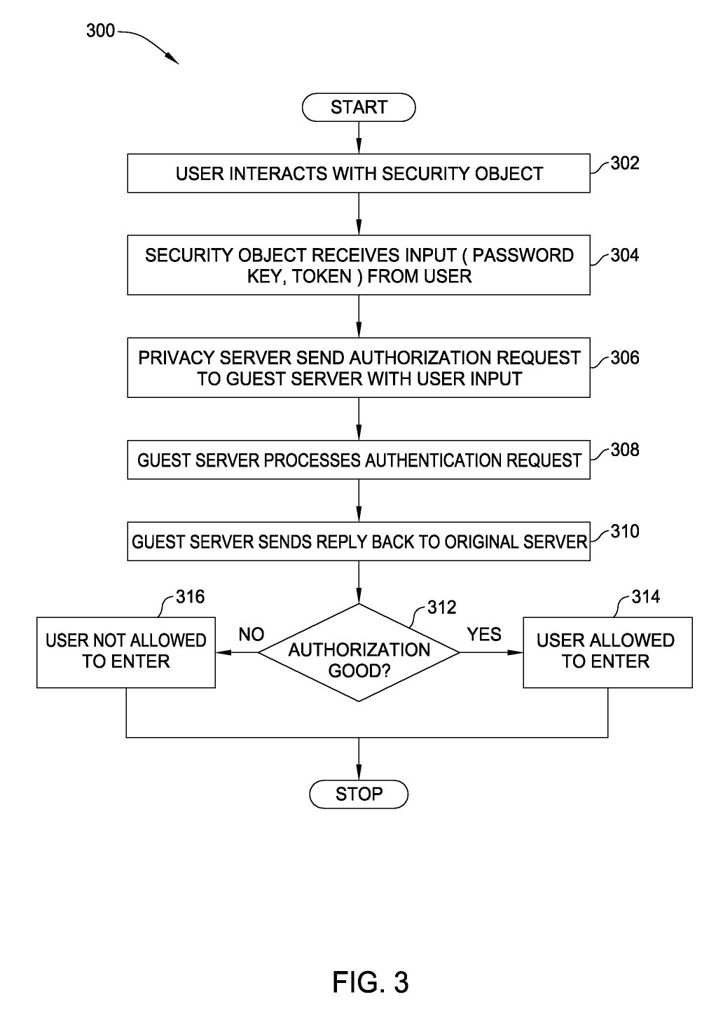

FIG. 3 is a flowchart illustrating a process 300 for an avatar 155 requesting entry into a guest environment 134, according to one embodiment of the invention. As shown, process 300 begins at step 302, where the avatar 155, interacts with a security interface object 156, such as the keypad 206 described in FIG. 2, or a virtual lock on a door providing entry to a guest environment 134. For example, the avatar 155 may enter a PIN on a keypad 206, or insert a virtual key object 156 into another security interface object 156, such as a virtual lock.

At step 304, the security object 156 receives the input from the avatar 155. The input may be the PIN value entered on the keypad 206. Alternately, the input may be an authentication code associated with a virtual world object 156, such as the virtual key object 156 described above.

At step 306, the primary server 142 sends an access request to the guest server 122 with the avatar input. More specifically, the primary interface component 160 on the primary server 142 may send the access request to the guest interface component 140 on the guest server 122.

At step 308, the guest server 122 processes the access request. Once in receipt of the authentication request, the guest interface component 140 may invoke the security component 138 to determine, based on the avatar input, whether the avatar 155 is authorized to transfer to the guest environment 134.

In turn, at step 310, the guest server 122, via the guest interface component 140, sends the reply to the authentication request to the primary server 142, via the primary interface component 160. At step 312, the primary interface component 160 determines whether to grant access to the requesting avatar. If so, at step 314, the avatar 155 is allowed to enter the guest environment 134, and the primary interface component 160 and guest interface component 140 may effectuate the transfer. If the access request is not granted, at step 316, the virtual world may display a message to the user, such as “Access to Guest Environment Denied.”

Embodiments of the invention may permit bidirectional transfer of avatars 155 between the virtual world 154 and the guest environment 134. Accordingly, the process 300 described above may apply to requests from avatars 155 in the guest environment 134 for entry to the virtual world 154. In such a case, the security object may be an object 136 within the guest environment 134, and the security component 158 on the primary server 142 may authenticate the access request.

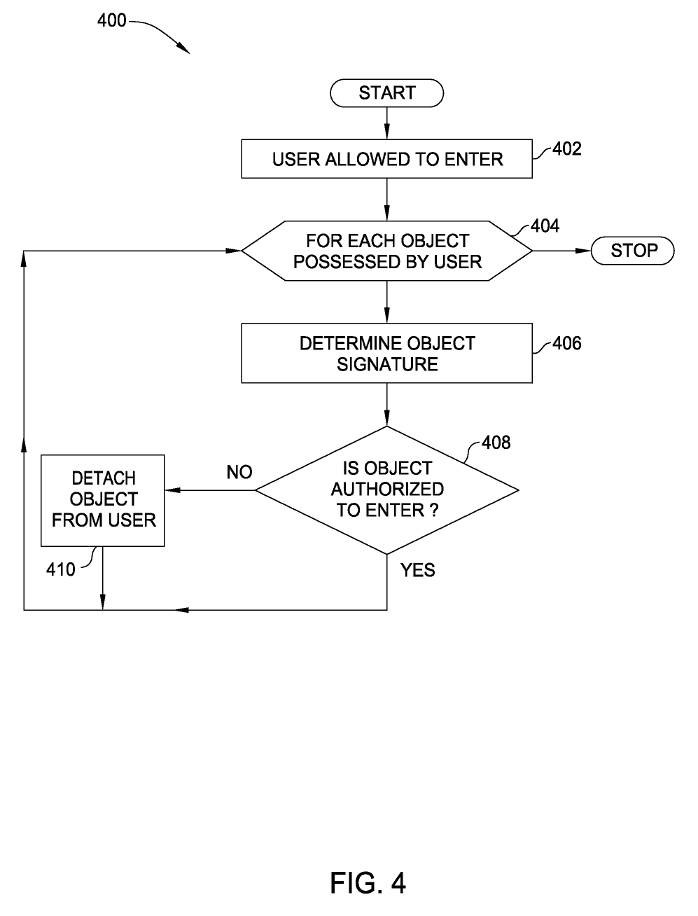

FIG. 4 is a flowchart illustrating a process 400 for requesting transfer of an object 156 into a guest environment 134, according to one embodiment of the invention. At step 402, an avatar 155 may be allowed to enter a guest environment 134 as described in step 314 of FIG. 3. At step 404, a loop begins for authenticating the transfer into the guest environment 134 of each object 156 that the avatar 155 possesses. The loop includes steps 406-410.

At step 406, the guest interface component 140 may determine an object signature for a given object. The object signature may be generated based on a cryptographic algorithm such as a hash function input a set of properties used to uniquely identify the object within the virtual world 154. Alternatively, the object signature may be determined be determined by retrieving a unique identifier assigned to each object in the virtual world (e.g., a UUID value generated for a given object) by the primary interface component 160 to validate its authenticity to guest environments 134.

At step 408, guest interface component 140 may determine whether the object is permitted transfer into the guest environment 134 based on the object signature. If the object 156 is permitted to transfer, the loop 404 repeats for the remaining objects 156 in the avatar's possession. If the object 156 is not permitted to transfer, at step 410, the guest environment 134 may dispossess the avatar 155 of the object 156. The guest environment 134 may present an image to the user of the avatar 155 appearing in the guest environment 134 while the object 156 vanishes from the avatar's possession. Alternately, the guest environment 134 may offer the user a choice to enter the environment 134 without the object 156, or to remain in the virtual world 154. In some embodiments, the avatar's authorization to enter the guest environment 134 may be revoked if any of the objects 156 in the avatar's possession are denied entry. Further, if any objects are removed from the avatar's possession, prior to that avatar entering the guest environment 134, such objects may be returned to the avatar upon return to the primary virtual environment.

Further, as avatar 155 in possession of an object 156, 136 may pass from the guest environment 134 to the virtual world 154, the process 400 may also be applied in the other direction. In such a scenario, the functions of the guest environment 134 and the guest interface component 140 described above may be accomplished by the virtual world 154, and the primary interface component 160, respectively. That is, upon an avatar's return to the virtual world 154 from the guest environment 134, the primary interface component 160 may evaluate each object in the avatar's possession and determine whether to remove any prohibited or unauthorized objects or to notify the avatar as described above.

Advantageously, embodiments of the invention allow a primary virtual world hosted on one server to interface with a guest environment hosted on another server. Doing so is useful for example, in situations where an individual or company has a desire to host their own area for purposes of security, privacy, or implementation freedom. Further, embodiments of the invention provide a method for avatars and elements of the primary virtual world or the guest environment to traverse from one to the other. Further still, rules related to what objects may be removed or transported between the primary virtual world and a guest environment may be enforced.

While the foregoing is directed to embodiments of the present invention, other and further embodiments of the invention may be devised without departing from the basic scope thereof, and the scope thereof is determined by the claims that follow.

What is claimed is:

1. A method of providing access to a secondary virtual environment from within a primary virtual environment hosted on a primary server system, comprising:
providing a secondary virtual environment hosted on a secondary server system;
providing a representation of the secondary virtual environment to be depicted in the primary virtual environment, wherein the representation includes a depiction of an entry point and an access mechanism used to request access to the secondary virtual environment;
receiving a request to transfer a presence of a client connected to the primary virtual environment to the secondary virtual environment, wherein the presence of the client in the primary virtual environment is represented using an avatar controlled by a user; and
upon authenticating the request, granting the request and receiving a transfer of the presence of the client from the primary virtual environment to the secondary virtual environment.

2. The method of claim 1, further comprising, prior to receiving the transfer of the client from the primary virtual environment to the secondary virtual environment, identifying one or more objects of the primary virtual environment possessed by the avatar associated with the requesting client; and
for any object possessed by the requesting avatar that is not authorized to be transferred from the primary virtual environment to the secondary virtual environment, removing the object from the possession of the avatar.

3. The method of claim 1, wherein the secondary virtual environment is represented in the primary virtual environment as an exterior of a structure.

4. The method of claim 3, wherein the exterior of the structure in the primary virtual environment includes an interface manipulated by the avatar to request access to the secondary virtual environment.

5. The method of claim 4, wherein access mechanism is depicted in the primary virtual environment as a keypad, and wherein the avatar enters a code known to the avatar to request access to the secondary virtual environment.

6. The method of claim 4, wherein access mechanism is depicted in the primary virtual environment as a locking mechanism, and wherein the avatar uses an object of the primary virtual environment to request access to the secondary virtual environment.

7. The method of claim 1, further comprising:
transferring the of the presence of the client from the secondary virtual environment back to the secondary virtual environment.

8. The method of claim 7, further comprising:
prior to transferring the of the presence of the client from the secondary virtual environment back to the secondary virtual environment, identifying one or more objects of the secondary virtual environment possessed by the requesting avatar; and
for any object possessed by the requesting avatar that is not authorized to be transferred from the primary virtual environment to the secondary virtual environment, removing the object from the possession of the avatar.

9. A computer-readable storage medium containing a program that when executed, performs an operation providing access to a secondary virtual environment from within a primary virtual environment hosted on a primary server system, the operation comprising:
providing a secondary virtual environment hosted on a secondary server system;
providing a representation of the secondary virtual environment to be depicted in the primary virtual environment, wherein the representation includes a depiction of an entry point and an access mechanism used to request access to the secondary virtual environment;
receiving a request to transfer a presence of a client connected to the primary virtual environment to the secondary virtual environment, wherein the presence of the client in the primary virtual environment is represented using an avatar controlled by a user; and
upon authenticating the request, granting the request and receiving a transfer of the presence of the client from the primary virtual environment to the secondary virtual environment.

10. The computer-readable storage medium of claim 9, wherein the operation further comprises, prior to receiving the transfer of the client from the primary virtual environment to the secondary virtual environment, identifying one or more objects of the primary virtual environment possessed by the avatar associated with the requesting client; and
for any object possessed by the requesting avatar that is not authorized to be transferred from the primary virtual environment to the secondary virtual environment, removing the object from the possession of the avatar.

11. The computer-readable storage medium of claim 9, wherein the secondary virtual environment is represented in the primary virtual environment as an exterior of a structure.

12. The computer-readable storage medium of claim 11, wherein the exterior of the structure in the primary virtual environment includes an interface manipulated by the avatar to request access to the secondary virtual environment.

13. The computer-readable storage medium of claim 12, wherein access mechanism is depicted in the primary virtual environment as a keypad, and wherein the avatar enters a code known to the avatar to request access to the secondary virtual environment.

14. The computer-readable storage medium of claim 12, wherein access mechanism is depicted in the primary virtual environment as a locking mechanism, and wherein the avatar uses an object of the primary virtual environment to request access to the secondary virtual environment.

15. The computer-readable storage medium of claim 9, wherein the operation further comprises:
transferring the of the presence of the client from the secondary virtual environment back to the secondary virtual environment.

16. The computer-readable storage medium of claim 15, wherein the operation further comprises:
prior to transferring the of the presence of the client from the secondary virtual environment back to the secondary virtual environment, identifying one or more objects of the secondary virtual environment possessed by the requesting avatar; and
for any object possessed by the requesting avatar that is not authorized to be transferred from the primary virtual environment to the secondary virtual environment, removing the object from the possession of the avatar.

17. A system, comprising:
a processor; and
a memory executing a program, wherein the program is configured to provide access to a secondary virtual environment from within a primary virtual environment hosted on a primary server system by:
providing a representation of the secondary virtual environment to be depicted in the primary virtual environment, wherein the representation includes a depiction of an entry point and an access mechanism used to request access to the secondary virtual environment,
receiving a request to transfer a presence of a client connected to the primary virtual environment to the secondary virtual environment, wherein the presence of the client in the primary virtual environment is represented using an avatar controlled by a user, and
upon authenticating the request, granting the request and receiving a transfer of the presence of the client from the primary virtual environment to the secondary virtual environment.

18. The system of claim 17, wherein the program is further configured to:
prior to receiving the transfer of the client from the primary virtual environment to the secondary virtual environment, identify one or more objects of the primary virtual environment possessed by the avatar associated with the requesting client; and
for any object possessed by the requesting avatar that is not authorized to be transferred from the primary virtual environment to the secondary virtual environment, remove the object from the possession of the avatar.

19. The system of claim 17, wherein the secondary virtual environment is represented in the primary virtual environment as an exterior of a structure.

20. The system of claim 19, wherein the exterior of the structure in the primary virtual environment includes an interface manipulated by the avatar to request access to the secondary virtual environment.

21. The system of claim 20, wherein access mechanism is depicted in the primary virtual environment as a keypad, and wherein the avatar enters a code known to the avatar to request access to the secondary virtual environment.

22. The system of claim 20, wherein access mechanism is depicted in the primary virtual environment as a locking mechanism, and wherein the avatar uses an object of the primary virtual environment to request access to the secondary virtual environment.

23. The system of claim 17, wherein the program is further configured to:
transfer the of the presence of the client from the secondary virtual environment back to the secondary virtual environment.

24. The system of claim 23, wherein the program is further configured to:
prior to transferring the of the presence of the client from the secondary virtual environment back to the secondary virtual environment, identify one or more objects of the secondary virtual environment possessed by the requesting avatar; and
for any object possessed by the requesting avatar that is not authorized to be transferred from the primary virtual environment to the secondary virtual environment, remove the object from the possession of the avatar.
